(19) United States
(12) Patent Application Publication
(10) Pub. No.: US 2018/0189864 A1
(43) Pub. Date: Jul. 5, 2018

(54) TECHNOLOGIES FOR PROPERTY MANAGEMENT AND RENTAL

(71) Applicant: RENTLEVER, LLC, San Francisco, CA (US)

(72) Inventors: G. Austin Allison, Cincinnati, OH (US); Scott Drexel, San Francisco, CA (US)

(21) Appl. No.: 15/909,896

(22) Filed: Mar. 1, 2018

Related U.S. Application Data
(63) Continuation of application No. 14/590,484, filed on Jan. 6, 2015.
(60) Provisional application No. 61/924,007, filed on Jan. 6, 2014.

(51) Int. Cl. G06Q 30/06; G06Q 10/02

(52) U.S. Cl. CPC G06Q 30/0645; G06Q 10/02

(57) ABSTRACT

Technologies for managing rental properties include a rental management device configured to determine whether a rental property is rented and transmit an access authorization message to a renter of the rental property via a remote computing device. The access authorization message includes access information required for entry to the rental property during a rental term. The rental management device determines whether the rental term is concluded and determines whether the rental property requires service. The computing device schedules a required service for the rental property in response to a determination that the rental property requires service. Additionally, the computing device may determine a recommended service vendor to perform the required service. Other embodiments are described and claimed.

### CROSS REFERENCE TO RELATED APPLICATIONS

This application is a continuation of U.S. non-provisional application Ser. No. 14/590,484, filed Jan. 6, 2015, which claims priority to U.S. Provisional Patent Application No. 61/924,007, filed Jan. 6, 2014, each of which is hereby incorporated herein by reference in its entirety.

### TECHNICAL FIELD

Embodiments of the technologies described herein relate, in general, to property management technologies, and in particular to an electronic platform for automating the private property rental management process.

### BACKGROUND

Data from a 2012 survey by the National Association of Realtors indicates that more than 7.7 million properties in the United States are designated as “second residences” for vacation or occasional use. The study found that over 70% of second home owners reported plans to rent their property at least once during a given year, putting as many as five million homes on the short or long-term United States rental market. Many property owners use third party management companies, often associated with high fees, to help manage their rentals.

### BRIEF DESCRIPTION OF THE DRAWINGS

The present disclosure will be more readily understood from a detailed description of some example embodiments taken in conjunction with the following figures in which:

FIG. 1 is a simplified block diagram of at least one embodiment of a system for managing private property rentals;

FIG. 2 is a simplified block diagram of at least one embodiment of an environment that may be executed by the rental management device of FIG. 1;

FIG. 3 is a simplified flow diagram of at least one embodiment of a method for managing private property rentals that may be executed by the rental management device of FIGS. 1 and 2;

FIG. 4 is a simplified flow diagram of at least one embodiment of a method for generating a binding rental agreement that may be executed by the rental management device of FIGS. 1 and 2;

FIG. 5 is a simplified flow diagram of at least one embodiment of a method for evaluating a rental property and determining required services that may be executed by the rental management device of FIGS. 1 and 2; and

FIG. 6 is a simplified flow diagram of at least one embodiment of a method for selecting a service vendor and scheduling a required service that may be executed by the rental management device of FIGS. 1 and 2.

### SUMMARY

A rental management device to manage rental properties includes a reservation management module configured to determine whether a rental property is rented and a property access management module configured to transmit an access authorization message to a renter of the rental property via a remote computing device in response to a determination that the rental property is rented. The access authorization message may include access information for gaining entry to the rental property during a rental term. The reservation management device further includes a rental property management module configured to determine whether the rental term is concluded, determine whether the rental property requires service in response to a determination that the rental term is concluded, and schedule a required service for the rental property in response to a determination that the rental property requires service.

In an embodiment, the property access management module is further configured to generate an access code for gaining entry to the rental property during the rental term via an electronic lock device of the rental property. In such embodiment, the access information of the access authorization message includes the access code. In an embodiment, the property access management module is further configured to receive, from an electronic lock device of the rental property, a generated access code for gaining entry to the rental property during the rental term. In such an embodiment, the access information of the access authorization message includes the generated access code. In another embodiment, the access information of the access authentication message includes instructions for gaining entry to the rental property during the rental term. In an embodiment, the access authorization message includes at least one of an electronic mail message or a short message service message. Additionally, in an embodiment, the property access management module is further to revoke authorization to access the rental property in response to a determination that the rental term is concluded and prevent the renter from gaining entry to the rental property. In such embodiment, to revoke the authorization to access the rental property includes to invalidate the access information for gaining entry to the rental property.

In an embodiment, the reservation management module is further configured to market the rental property to one or more prospective renters. Additionally, in an embodiment, to market the rental property to the one or more prospective renters includes to transmit rental property data to a remote rental marketing server. In such embodiment, the rental property data includes one or more of property description information, rental restriction information, renter requirement information, availability information, or pricing information associated with the rental property. Additionally, in an embodiment, the reservation management module is further configured to determine the one or more prospective renters for the rental property based on a renter profile generated for each of the one or more prospective renters. In such embodiment, the renter profile for each of the one or more prospective renters includes one or more of preferred location information, preferred rental floorplan information, preferred rental price information, preferred payment methods, or historical rental information. Additionally, in such embodiment, to market the rental property to the one or more prospective renters includes to market the rental property to the determined one or more prospective renters for the rental property.

Additionally, in an embodiment, the reservation management module is further configured to receive, from the remote computing device, a request from a prospective renter to rent the rental property, transmit a rental agreement to the prospective renter for rental of the rental property, and receive a signed rental agreement from the prospective renter via the remote computing device. In such embodiment, the signed rental agreement includes the transmitted rental agreement digitally signed by the prospective renter. Additionally, in such embodiment, to determine whether the rental property is rented includes to determine whether the signed rental agreement is received from the prospective renter.

In an embodiment, the rental property management module is further configured to receive property evaluation data associated with the rental property and analyze the received property evaluation data. In such an embodiment, the property evaluation data is indicative of a condition of the rental property obtained in response to the determination that the rental term is concluded. Additionally, in such embodiment, to determine whether the rental property requires service includes to determine whether the rental property requires service as a function of the analyzed property evaluation data.

In an embodiment, the property evaluation data includes a property inspection report. In such embodiment, to analyze the property evaluation data includes to compare the property inspection report to baseline property evaluation data. Additionally, to determine whether the rental property requires service includes to determine whether the rental property requires service based on the comparison of the property inspection report to the baseline property evaluation data.

Additionally, in an embodiment, the rental property management module is further configured to receive sensor data from a sensor of the rental property and compare the received sensor data to baseline property evaluation data. In such an embodiment, to determine whether the rental property requires service includes to determine whether the rental property requires service based on the comparison of the received sensor data to the baseline property evaluation data. Additionally, in such embodiment, the received sensor data includes at least one of an image received from an image sensor of the rental property, air quality data received from an environmental sensor of the rental property, access data received from a motion sensor of the rental property, or asset data received from an asset control sensor of the rental property.

In an embodiment, the rental property management module is further configured to determine a recommended service vendor from a plurality of service vendors to perform the required service, transmit a message identifying the recommended service vendor to perform the required service to an owner of the rental property for approval, and receive an approval message indicative of an approval by the owner of the recommended service vendor. In such embodiment, to schedule the required service for the rental property includes to schedule the recommended service vendor to perform the required service in response to receipt of the approval message. In an embodiment, to determine the recommended service vendor includes to select a service vendor from the plurality of service vendors based on one or more of a location of each of the plurality of service vendors, a rating of each of the plurality of service vendors, a ranking of each of the plurality of service vendors, an availability of each of the plurality of service vendors, or a service price associated with each of the plurality of services vendors. Additionally, in an embodiment, the rental property management module is further configured to determine whether a preferred service vendor is specified to perform the required service. In such embodiment to schedule the required service for the rental property includes to schedule the preferred service vendor to perform the required service in response to a determination that the preferred service vendor is specified.

One or more machine-readable storage media include a plurality of instructions stored thereon that in response to being executed by a rental management computing device, cause the rental management computing device to determine whether a rental property is rented. The plurality of instructions further cause the rental management computing device to transmit an access authorization message to a renter of the rental property via a remote computing device in response to a determination that the rental property is rented. The access authorization message includes access information for gaining entry to the rental property during a rental term. The plurality of instructions further cause the rental management computing device to determine whether the rental term is concluded, determine whether the rental property requires service in response to a determination that the rental term is concluded, and schedule a required service for the rental property in response to a determination that the rental property requires service.

In an embodiment, the plurality of instructions further cause the rental management computing device to receive property evaluation data associated with the rental property. In such embodiment the property evaluation data is indicative of a condition of the rental property obtained in response to the determination that the rental term is concluded. In such embodiment, the plurality of instructions further cause the rental management computing device to analyze the property evaluation data. Additionally, in such embodiment, to determine whether the rental property requires service includes to determine whether the rental property requires service as a function of the analyzed property evaluation data.

In an embodiment, the plurality of instructions further cause the rental management computing device to determine a recommended service vendor from a plurality of service vendors to perform the required service and transmit a message identifying the recommended service vendor to perform the required service to an owner of the rental property for approval. In such embodiment, the plurality of instructions further cause the rental management computing device to receive an approval message indicative of an approval by the owner of the recommended service vendor. Additionally, in such embodiment, to schedule the required service for the rental property includes to schedule the recommended service vendor to perform the required service in response to receipt of the approval message. Additionally, in an embodiment, the plurality of instructions further cause the rental management computing device to determine whether a preferred service vendor is specified to perform the required service. Additionally, in such embodiment, to schedule the required service for the rental property includes to schedule the preferred service vendor to perform the required service in response to a determination that the preferred service vendor is specified.

A method for managing rental properties includes determining, by a rental management device, whether a rental property is rented. The method further includes transmitting, by the rental management device and in response to determining that the rental property is rented, an access authorization message to a renter of the rental property via a remote computing device. The access authorization message includes access information for gaining entry to the rental property during a rental term. The method further includes determining, by the rental management device, whether the rental term is concluded and determining, by the rental management device and in response to determining that the rental term is concluded, whether the rental property requires service. Additionally, the method further includes scheduling, by the rental management device and in response to determining that the rental property requires service, the required service for the rental property.

In an embodiment, the method further includes receiving, by the rental management device, property evaluation data associated with the rental property. In such embodiment, the property evaluation data is indicative of a condition of the rental property obtained in response to determining that the rental term is concluded. In such embodiment, the method further includes analyzing, by the rental management device, the property evaluation data. Additionally, in such embodiment, determining whether the rental property requires service includes determining whether the rental property requires service as a function of the analyzed property evaluation data.

Additionally, in an embodiment, the method further includes determining, by the rental management device, a recommended service vendor from a plurality of service vendors to perform the required service. In such embodiment, the method further includes transmitting, by the rental management device, a message identifying the recommended service vendor to perform the required service to an owner of the rental property for approval and receiving, by the rental management device, an approval message indicative of an approval by the owner of the recommended service vendor. Additionally, in such embodiment, scheduling the required service for the rental property includes scheduling the recommended service vendor to perform the required service in response to receiving the approval message.

### DETAILED DESCRIPTION

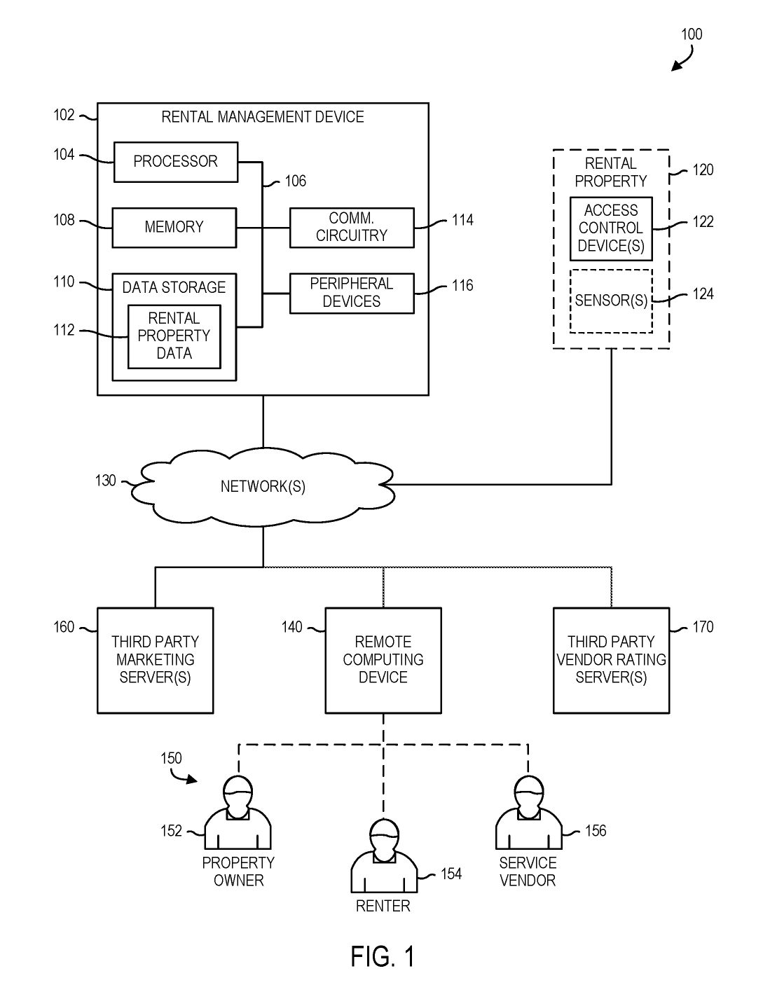

Various non-limiting embodiments of the present disclosure will now be described to provide an overall understanding of the principles of the structure, function, and use of systems and methods disclosed herein. One or more examples of these non-limiting embodiments are illustrated in the selected examples disclosed and described in detail with reference made to FIGS. 1-6 in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

The systems, apparatuses, devices, and methods disclosed herein are described in detail by way of examples and with reference to the figures. The examples discussed herein are examples only and are provided to assist in the explanation of the apparatuses, devices, systems and methods described herein. None of the features or components shown in the drawings or discussed below should be taken as mandatory for any specific implementation of any of these the apparatuses, devices, systems or methods unless specifically designated as mandatory. In addition, elements illustrated in the figures are not necessarily drawn to scale for simplicity and clarity of illustration. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context. It should be noted that although for clarity and to aid in understanding some examples discussed herein might describe specific features or functions as part of a specific component or module, or as occurring at a specific layer of a computing device (for example, a hardware layer, operating system layer, or application layer), those features or functions may be implemented as part of a different component or module or operated at a different layer of a communication protocol stack. Those of ordinary skill in the art will recognize that the systems, apparatuses, devices, and methods described herein can be applied to, or easily modified for use with, other types of equipment, can use other arrangements of computing systems such as client-server distributed systems, and can use other protocols, or operate at other layers in communication protocol stacks, than are described.

Referring now to FIG. 1, in one embodiment, a system 100 for managing property rentals includes a rental management device 102 configured to communicate with a remote computing device 140 over one or more networks 130. In some embodiments, the rental management device 102 is also configured to communicate with one or more third party marketing servers 160 and/or one or more third party vendor rating servers 170 via the network(s) 130. In operation, the rental management device 102 markets (e.g., advertises, promotes, publicizes, etc.) a rental property 120 to one or more prospective renters such as, for example, the renter 154. The rental management device 102 also electronically manages reservations and schedules bookings for the rental property 120. For example, in the illustrative embodiment, the rental management device 102 manages physical access to the rental property 120 by one or more users 150 (e.g., the property owner 152, the renter 154, a service vendor 156, etc.). To do so, in some embodiments, the rental management device 102 provides the user(s) 150 with a temporary access code configured to grant entry into all or a portion of the rental property 120 via a locking device (e.g., an electronic lockbox, a push-button lockbox, an electronic door lock, etc.) located at or proximate to the rental property 120. In other embodiments, the rental management device 102 provides the user(s) 150 with instructions on how to gain entry to all or a portion of the rental property 120 as discussed in more detail below.

The rental management device 102 also determines whether any services are required to be performed at the rental property 120. For example, in some embodiments, the rental management device 102 determines whether the rental property 120 requires housekeeping, maintenance, groundskeeping, or any other type of service either prior or subsequent to the rental property 120 being rented out. The rental management device 102 may also automatically schedule, confirm, track, and process payment for services required at the rental property 120.

In some embodiments, the rental management device 102 may automatically recommend one or more service vendors 156 to perform a required service at the rental property 120. In some embodiments, the recommendation may be made based on one or more or a combination of the location and/or proximity of a service vendor 156 to the rental property 120, the availability of a service vendor 156, ratings or rakings associated with a service vendor 156, service prices charged by a service vendor 156, or any other criteria suitable for selecting a particular service vendor 156 to recommend from a plurality of service vendors 156. In such embodiments, the rental management device 102 presents the recommended service vendor 156 to the property owner 152 and, in response to receiving approval of the recommend service vendor 156, automatically schedules the service and pays service vendor invoices upon completion of the scheduled service.

In the illustrative embodiment, one or more users 150 interact with the rental management device 102 via the remote computing device 140. For example, in some embodiments, one or more property owners 152 interact with the rental management device 102 via the remote computing device 140 to monitor and manage the renting of properties, such as, the rental property 120. Additionally, one or more renters 154 interact with the rental management device 102 via the remote computing device 140 to locate and book a stay at one or more rental properties 120. One or more service vendors 156 also interact with the rental management device 102 via the remote computing device 140. Such service vendors 156 interact with the rental management device 102 to advertise their services, availability, and invoice the owner of a rental property at which service was performed.

The rental management device 102 may be embodied as any type of server or computing device capable of processing, communicating, storing, maintaining, and transferring data. For example, the rental management device 102 may be embodied as a server, a microcomputer, a minicomputer, a mainframe, a desktop computer, a laptop computer, a mobile computing device, a handheld computer, a smart phone, a tablet computer, a personal digital assistant, a telephony device, a custom chip, an embedded processing device, or other computing device and/or suitable programmable device. In some embodiments, the rental management device 102 may be embodied as a computing device integrated with other systems or subsystems. In the illustrative embodiment of FIG. 1, the rental management device 102 includes a processor 104, a system bus 106, a memory 108, a data storage 110, communication circuitry 114, and one or more peripheral devices 116. Of course, the rental management device 102 may include other or additional components, such as those commonly found in a server and/or computer (e.g., various input/output devices), in other embodiments. Additionally, in some embodiments, one or more of the illustrative components may be incorporated in, or otherwise from a portion of, another component. For example, the memory 108, or portions thereof, may be incorporated in the processor 104 in some embodiments. Furthermore, it should be appreciated that the rental management device 102 may include other components, sub-components, and devices commonly found in a computer and/or computing device, which are not illustrated in FIG. 1 for clarity of the description.

The processor 104 may be embodied as any type of processor capable of performing the functions described herein. For example, the processor 104 may be embodied as a single or multi-core processor, a digital signal processor, microcontroller, a general purpose central processing unit (CPU), a reduced instruction set computer (RISC) processor, a processor having a pipeline, a complex instruction set computer (CISC) processor, an application specific integrated circuit (ASIC), a programmable logic device (PLD), a field programmable gate array (FPGA), or other processor or processing/controlling circuit or controller.

In various configurations, the rental management device 102 includes a system bus 106 for interconnecting the various components of the rental management device 102. The system bus 106 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations with the processor 104, the memory 108, and other components of the rental management device 102. In some embodiments, the rental management device 102 can be integrated into one or more chips such as a programmable logic device or an application specific integrated circuit (ASIC). In such embodiments, the system bus 106 may form a portion of a system-on-a-chip (SoC) and be incorporated, along with the processor 104, the memory 108, and other components of the rental management device 102, on a single integrated circuit chip.

The memory 108 may be embodied as any type of volatile or non-volatile memory or data storage capable of performing the functions described herein. For example, the memory 108 may be embodied as read only memory (ROM), random access memory (RAM), cache memory associated with the processor 104, or other memories such as dynamic RAM (DRAM), static ram (SRAM), programmable ROM (PROM), electrically erasable PROM (EEPROM), flash memory, a removable memory card or disk, a solid state drive, and so forth. In operation, the memory 108 may store various data and software used during operation of the rental management device 102 such as operating systems, applications, programs, libraries, and drivers.

The data storage 110 may be embodied as any type of device or devices configured for short-term or long-term storage of data such as, for example, memory devices and circuits, memory cards, hard disk drives, solid-state drives, or other data storage devices. For example, in some embodiments, the data storage 110 includes storage media such as a storage device that can be configured to have multiple modules, such as magnetic disk drives, floppy drives, tape drives, hard drives, optical drives and media, magneto-optical drives and media, compact disk drives, Compact Disk Read Only Memory (CD-ROM), Compact Disk Recordable (CD-R), Compact Disk Rewriteable (CD-RW), a suitable type of Digital Versatile Disk (DVD) or Blu-Ray disk, and so forth. Storage media such as flash drives, solid state hard drives, redundant array of individual disks (RAID), virtual drives, networked drives and other memory means including storage media on the processor 104, or the memory 108 are also contemplated as storage devices. It should be appreciated that such memory can be internal or external with respect to operation of the disclosed embodiments. It should also be appreciated that certain portions of the processes described herein can be performed using instructions stored on a computer-readable medium or media that direct or otherwise instruct a computer system to perform the process steps. Non-transitory computer-readable media, as used herein, comprises all computer-readable media except for transitory, propagating signals.

In some embodiments, the data storage 110 includes rental property data 112. The rental property data 112 may include data associated with multiple rental properties. For example, the rental property data 112 may include property information, rental information, privacy information, renter requirements, rental availability, rental restrictions, rental pricing information, preferences, property condition check-lists, owner profile data, and any other type of data associated with a rental property, such as the rental property 120. The data storage 110 may also include other types of data associated with the marketing, management, and rental of rental properties. For example, in some embodiments the data storage 110 includes renter profile data associated with one or more renters 154 (e.g., prospective renters, previous renters, current renters, etc.) of the rental properties. The renter profile data may include contact and/or preference data (e.g., preferred locations, floorplans, price points, payment methods, etc.) associated with each of the renters 154. Additionally, in some embodiments, the data storage 110 may also include service vendor data associated with one or more service vendors 156. The service vendor data may include contact data, service-related data (e.g., type of service(s) offered, price for offered services, etc.), availability data, rating or ranking data, and any other type of data associated with each of the service vendors 156.

The communication circuitry 114 of the rental management device 102 may be embodied as any type of communication circuit, device, interface, or collection thereof, capable of enabling communications between the rental management device 102 and the remote computing device 140, the third party marketing server(s) 160, the third party vendor rating server(s) 170, and/or other computing devices. For example, the communication circuitry 114 may be embodied as one or more network interface controllers (NICs), in some embodiments. The communication circuitry 114 may be configured to use any one or more communication technologies (e.g., wireless or wired communications) and associated protocols (e.g., Ethernet, Wi-Fi®, WiMAX, etc.) to effect such communication.

In some embodiments, the rental management device 102 and the remote computing device 140, the third party marketing server(s) 160, and the third party vendor rating server(s) 170 may communicate with each other over the network(s) 130. The network(s) 130 may be embodied as any number of various wired and/or wireless communication networks. For example, the network(s) 130 may be embodied as or otherwise include a local area network (LAN), a wide area network (WAN), a cellular network, or a publicly-accessible, global network such as the Internet. Additionally, the network(s) 130 may include any number of additional devices to facilitate communication between the rental management device 102, the remote computing device 140, the third party marketing server(s) 160, the third party vendor rating server(s) 170, and/or other computing devices.

Additionally, in some embodiments, the rental management device 102 may further include one or more peripheral devices 116. Such peripheral devices 116 may include any type of peripheral device commonly found in a computing device such as additional data storage, speakers, a hardware keyboard, a keypad, a gesture or graphical input device, a motion input device, a touchscreen interface, one or more displays, an audio unit, a voice recognition unit, a vibratory device, a computer mouse, a peripheral communication device, and any other suitable user interface, input/output device, and/or other peripheral device.

The rental property 120 may be embodied as any type of property owned by an individual or an entity (e.g., a timeshare company, a cooperative, a vacation company, a corporation, a governmental entity, etc.) that can be rented or leased to any other individual or entity for a defined term (e.g., a defined time period). For example, in some embodiments, the rental property 120 may be embodied as a vacation home, an apartment, a condominium, a hotel room, a bedroom, a building floor, and/or any other type of building or portion of a building. It should be appreciated that although only one rental property 120 is illustratively shown in FIG. 1, any number of rental properties 120 may be managed by rental management device 102 in other embodiments.

The rental property 120 may include one or more access control devices 122. The access control device(s) 122 are configured to control access into or from all or a portion of the rental property 120. For example, in some embodiments, an access control device 122 may be configured to control ingress and egress to the rental property 120 through a main entrance (e.g., a doorway or other form of ingress and egress). In another embodiment, a different access control device 122 of the rental property 120 may control ingress and egress to a portion of the rental property 120 (e.g., a supply closet, an owner's closet, a wine cellar, etc.). In that way, access control devices 122 may be layered to provide different users 150 (e.g., the property owner 152, the renter(s) 154, the service vendor(s) 156, etc.) access to different portions of the rental property 120.

In some embodiments, the access control device(s) 122 of the rental property 120 may be embodied as a manual lock device (e.g., a door lock, a deadbolt lock, etc.). In such embodiments, a user 150 (e.g., the property owner 152, renter(s) 154, service vendor(s) 156, etc.) may be provided with instructions for obtaining the key needed to unlock the manual lock device as discussed in more detail below. Additionally, in some embodiments, the access control device(s) 122 of the rental property 120 may be embodied as an electronic or digital lock device (e.g., an electronic lockbox, a push-button lockbox, an electronic door lock, etc.). In such embodiments, the access control device(s) 122 (i.e., the electronic or digital lock devices) may be configured control entry into or exit from the rental property 120 based on an access code. To do so, in some embodiments, the access control device(s) 122 may receive the access code via manual input via a keypad or other input device and determine whether to permit or prevent access based at least in part on, or otherwise as a function of, the received access code. In other embodiments, the access code may be encoded on an electronic smartcard or a magnetic room key. In such embodiments, the access control device(s) 122 may include suitable reader devices to read or otherwise obtain the access code from the electronic smartcard or magnetic room key and thereby permit or prevent access to the rental property 120. It should be appreciated that any suitable technology may be used by the access control device(s) 122 to receive the access code.

In embodiments in which the access control device(s) 122 of the rental property 120 are embodied as electronic or digital lock device(s), the access code may be generated locally or remotely. For example, the access control device(s) 122 of the rental property 120 may generate and transmit the access code to the rental management server 102. Additionally or alternatively, in some embodiments, the rental management device 102 may generate the access code. In such embodiments, the rental management device 102 may transmit the access code to the access control device(s) 122 for later comparison with an access code provided by a user 150 (e.g., the property owner 152, renter(s) 154, service vendor(s) 156, etc.) to gain entry into the rental property 120 or a portion thereof.

In some embodiments, the rental property 120 includes one or more sensors 124. The sensor(s) 124 may be embodied as any type of device or devices configured to sense characteristics or conditions of the rental property 120. For example, the sensor(s) 124 may be embodied as or otherwise include an image sensor (e.g., a digital still camera, a video camera, etc.) configured to generate and analyze images of the rental property 120, an environmental sensor configured to measure or sense the air quality or temperature of the rental property 120, a motion or proximity sensor configured to detect whether the rental property 120 or a portion thereof was accessed, an asset tracking sensor configured to detect whether objects (e.g., furniture, televisions, electronics, minibar items, decorations, linens, etc.) are removed from the rental property 120. It should be appreciated that the rental property 120 may also include any other type of sensor 124 configured to sense any other characteristic or condition.

The remote computing device 140 may be embodied as any type of computing device capable of performing the functions described herein. As such, the remote computing device 140 may include devices and structures commonly found in computing devices such as processors, memory devices, communication circuitry, and data storages, which are not shown in FIG. 1 for clarity of the description. In some embodiments, the remote computing device 140 is configured to send and receive rental property data 112 to and from the rental management device 102. Additionally, the remote computing device 140 is configured to enable one or more users 150 (e.g., the property owner 152, the renter 154, the service vendor 156, etc.) to access the rental management device 102 for managing, renting, and/or servicing various rental properties (e.g., the rental property 120). To do so, in some embodiments, the remote computing device 140 may be configured to access or otherwise communicate with the rental management device 102 via one or more web pages (e.g., HTML pages, PHP pages, etc.) or a web-browser application (e.g., an HTML application or the like). For example, in such embodiments, the user 150 may utilize a web-browser executing on the remote computing device 140 such as Safari™, Opera™, Google™ Chrome™, Internet Explorer™, or the like to interact with the rental management device 102.

The third party marketing server(s) 160 may be embodied as any type of computing devices capable of performing the functions described herein. As such, the third party marketing server(s) 160 may include devices and structures commonly found in computing devices such as processors, memory devices, communication circuitry, and data storages, which are not shown in FIG. 1 for clarity of the description. In some embodiments, the third party marketing server(s) 160 are configured to market the rental property 120 (or multiple rental properties 120) based on rental property data 112 (e.g., rental property description information, privacy information, renter requirements, rental availability, rental restrictions, rental pricing information, preferences, owner profile data, etc.) received from the rental management device 102. In some embodiments, the third party marketing server(s) 160 may be embodied as one or more socially-driven marketplaces such as, for example, VRBO, HOMEAWAY, AIRBNB, and CRAIGSLIST. It should be appreciated that the third party marketing server(s) 160 may also be embodied as one or more conventional vacation rental marketplaces (e.g., EXPEDIA, KAYAK, hotel websites, airline websites, etc.).

The third party vendor rating server(s) 170 may be embodied as any type of computing devices capable of performing the functions described herein. As such, the third party vendor rating server(s) 170 may include devices and structures commonly found in computing devices such as processors, memory devices, communication circuitry, and data storages, which are not shown in FIG. 1 for clarity of the description. In some embodiments, the third party vendor rating server(s) 170 are configured to track and provide ratings and/or rankings for one or more service vendors 156. For example, the third party vendor rating server(s) 170 may be embodied as, or provide services similar to, rating services and social rating services such as TASKRABBIT or YELP. In some embodiments, the third party vendor rating server(s) 170 are configured to provide service vendor ratings and/or rankings to the rental management device 102. As discussed in more detail below, the rental management device 102 may be configured to determine a recommended service vendor 156 to provide a required service for a rental property 120 based at least in part on the ratings and/or rankings received from the third party vendor rating server(s) 170.

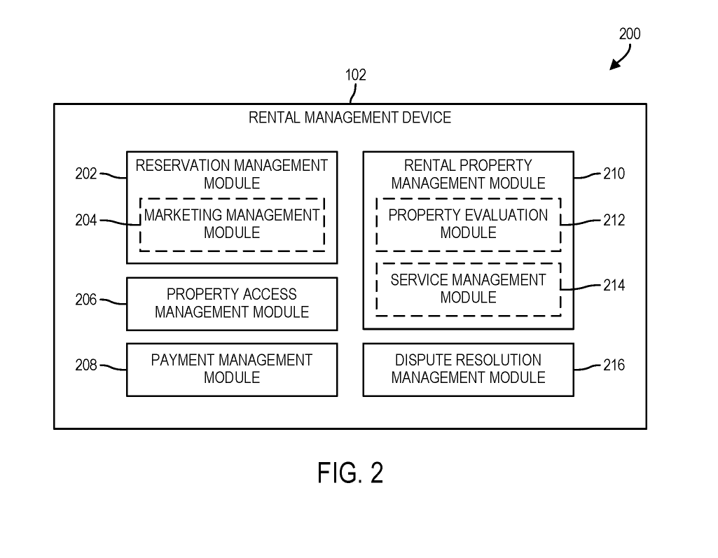

Referring now to FIG. 2, in the illustrative embodiment, the rental management device 102 establishes an environment 200 during operation. The illustrative embodiment 200 includes a reservation management module 202, a property access management module 206, a payment management module 208, a rental property management module 210, and a dispute resolution management module 216. In some embodiments, the reservation management module 202 includes a marketing management module 204 as discussed in more detail below. Additionally, in some embodiments, the rental property management module 210 includes a property evaluation module 212 and a service management module 214 as discussed in more detail below. The various modules of the environment 200 may be embodied as hardware, firmware, software, or a combination thereof. For example, each of the modules of the environment 200 may be embodied as a processor and/or a controller configured to provide the functionality described below. Of course, it should be appreciated that the rental management device 102 may include other components, sub-components, modules, and devices commonly found in a computing device, which are not illustrated in FIG. 2 for clarity of the description.

The reservation management module 202 is configured to manage and schedule bookings of the rental property 120 (or multiple rental properties) made by renters 154 and/or prospective renters. To do so, in some embodiments, the reservation management module 202 is configured to receive a request from a prospective renter 154 to rent the rental property 120. The rental request may be received from the remote computing device 140. In response to receiving the rental request, the reservation management module 202 may be configured to confirm the reservation (e.g., the booking). Additionally or alternatively, the reservation management module 202 is configured to determine whether the rental property 120 is rented and for what duration (e.g., the rental term).

In some embodiments, the reservation management module 202 is configured to manage one or more calendars or integrate with one or more online marketplace calendars to ensure that reservations (e.g., bookings) for the rental property 120 (or each rental property) are tracked and no double-bookings occur. In some embodiments, the rental property 120 may be associated with an online or electronic calendar. In embodiments in which the reservation management module 202 is configured to manage and schedule bookings for multiple rental properties, each rental property may be associated with a separate online or electronic calendar. Additionally or alternatively, one or more of the rental properties may share an online or electronic calendar.

Additionally, in some embodiments, the reservation management module 202 is configured to create a binding rental agreement with the prospective renter 154. To do so, the reservation management module 202 is configured to provide a rental agreement for the rental property 120 to the prospective renter 154 via the remote computing device 140. The reservation management module 202 is also configured to receive a digitally signed version of the rental agreement from the prospective renter 154. It should be appreciated that the reservation management module 202 may also be configured to facilitate revising and negotiating existing or additional terms of the rental agreement prior to being signed and returned by the prospective renter 154. Further, in some embodiments, the reservation management module 202 may also be configured to receive an electronic copy of the rental agreement physically signed by the prospective renter 154.

The reservation management module 202 is also configured manage the rental property data 112 associated with the rental property 120 (or multiple rental properties). As discussed, the rental property data 112 may include property information, rental information, privacy information, renter requirements, rental availability, rental restrictions, rental pricing information, preferences, property condition check-lists, owner profile data, and any other type of data associated with the rental property 120. In some embodiments, the rental property data 112 may be embodied as a profile of the rental property 120. In such embodiments, the reservation management module 202 may be configured to generate one or more interfaces to enable the owner 152 of the rental property 120 to update the profile of the rental property 120.

Additionally, the reservation management module 202 is also configured to facilitate marketing of the rental property 120 (or multiple rental properties). To do so, in some embodiments, the reservation management module 202 includes the marketing management module 204. The marketing management module 204 may be configured to market the rental property 120 to one or more prospective renters 154. To do so, in some embodiments, the marketing management module 204 is configured to transmit the rental property data 112 (e.g., rental property description information, privacy information, renter requirements, rental availability, rental restrictions, rental pricing information, preferences, owner profile data, etc.) directly to the prospective renter(s) 154 via the remote computing device 140 or indirectly via another computing device. For example, the marketing management module 204 may transmit the rental property data 112 to one or more of the third party marketing servers 160. In such embodiments, the prospective renter(s) 154 may access or otherwise obtain the rental property data 112 from the third party marketing server(s) 160.

As discussed, in some embodiments, the marketing management module 204 is configured to transmit the rental property data 112 directly to the prospective renter(s) 154 via the remote computing device 140. In such embodiments, the marketing management module 204 may be configured to compare the rental property data 112 to a renter profile generated for each prospective renter 154. In such embodiments, the renter profile generated for each prospective renter 154 may include contact and/or preference data (e.g., preferred locations, floorplans, price points, payment methods, etc.) associated with each of the prospective renters 154. If the marketing management module 204 determines that the rental property data 112 for the rental property 120 matches or meets information included in a particular renter's profile, that renter may be identified by the marketing management module 204 as being a prospective renter 154. In such cases, the marketing management module 204 may transmit the rental property data 112 directly to the identified prospective renter(s) 154.

The property access management module 206 is configured to control or manage physical access to the rental property 120 or a portion thereof. To do so, the property access management module 206 is configured to authorize one or more users 150 (e.g., the property owner 152, the renter(s) 154, the service vendor(s) 156, etc.) to access the rental property 120. In some embodiments, the property access management module 206 is configured generate an access authorization message to the renter 154 (or other user 150) of the rental property 120. The access authorization message includes access information required for gaining entry to the rental property 120. For example, in embodiments in which the rental property 120 includes one or more electronic access control device(s) 122 (e.g., electronic or digital lock devices), the access information may include an access code for gaining entry into the rental property 120 or a portion thereof. In such embodiments, the access code may be used by the renter 154 (or other user 150) to gain entry to the rental property 120 via the electronic access control device(s) 122. The access code may be generated by the property access management module 206 or it may be received from the electronic access control device(s) 122. In embodiments in which the rental property 120 includes one or more manual access control device(s) 122, the access information may include access instructions for gaining entry to the rental property 120. In such embodiments, the renter 154 (or other user 150) may use the access instruction to obtain a physical key needed to gain entry into the rental property 120 or a portion thereof.

The property access management module 206 is also configured to revoke authorization to access the rental property 120. In doing so, the property access management module 206 may prevent the renter 154 (or other user 150) from gaining entry to the rental property 120 or a portion thereof. To do so, in some embodiments, the property access management module 206 may invalidate the access information required for gaining entry to the rental property 120 or a portion thereof. Additionally or alternatively, the property access management module 206 may rescind or deactivate the access code in embodiments in which the rental property 120 includes electronic access control device(s) 122 (e.g., electronic or digital lock devices). It should be appreciated that the property access management module 206 may use any suitable mechanism for revoking the renter's 154 (or other user's 150) authorization to access the rental property 120.

The payment management module 208 is configured to process payment transactions associated with the rental property 120 (or multiple rental properties). For example, in some embodiments, the payment management module 208 is configured to generate invoices and accept rent payments directly from the renter(s) 154 of the rental unit 120 via credit card, wire transfer, electronic check, electronic withdrawal, and the like. Additionally or alternatively, the payment management module 208 is also configured to process invoices and make payments to one or more service vendors 156 after provision of a service at the rental property 120. In some embodiments, the payment management module 208 is also configured to integrate with payment systems offered by various online vacation rental marketplaces.

The rental property management module 210 is configured to evaluate the rental property 120 and determine whether any services are required at the rental property 120. As such, in some embodiments, the rental property management module 210 includes the property evaluation module 212. The property evaluation module 212 is configured to receive property evaluation data associated with the rental property 120. The property evaluation data may be received at the conclusion of the rental term of the rental property 120 from an independent inspector and/or one or more sensors 124 of the rental property 120. The property evaluation module 212 may compare the property evaluation data to baseline property evaluation data associated with the rental property 120. The baseline property evaluation data may be embodied as data indicative of a reference or default condition level (e.g., cleanliness level, functionality level, etc.) that the owner 152 requires the rental property 120 to be returned to after conclusion of a rental term. In some embodiments, the property evaluation module 212 may determine any differences between the received property evaluation data and the baseline property evaluation data associated with the rental property 120. In such embodiments, the property evaluation module 212 is configured to determine the service(s) that are required to be performed at the rental property 120 based on the differences between the received property evaluation data and the baseline property evaluation data.

The rental property management module 210 is also configured to automatically schedule, confirm, and track services required to be performed at the rental property 120. As such, in some embodiments, the rental property management module 210 includes the service management module 214. In some embodiments, the service management module 214 is configured to determine whether the owner 152 of the rental property 120 has specified a preferred or default service vendor 156 to perform the required service. If so, the service management module 214 will automatically schedule the preferred service vendor 156 to perform the service. In embodiments in which the service management module 214 determines instead that the owner 152 of the rental property 120 has not specified a preferred or default service vendor 156 to perform the required service, the service management module 214 may be configured to select or recommend a service vendor 156 from a plurality of service vendors to perform the required service. To do so, the service management module 214 may select or determine a particular service vendor 156 to recommend based at least in part on, or otherwise as a function of, a location of each of the plurality of service vendors 156, a rating of each of the plurality of service vendors 156, a ranking of each of the plurality of service vendors 156, an availability of each of the plurality of service vendors 156, a service price associated with each of the plurality of service vendors 156, and/or a combination thereof. For example, in a specific embodiment, the service management module 214 may select the service vendor 156 determined to be closest to the rental property 120. In another specific embodiment, the service management module 214 may select the service vendor 156 having the highest rating or ranking, which may be tracked by the service management module 214 and/or the third party vendor rating server(s) 170. It should be appreciated that the service management module 214 may utilize any other criteria for determining or selecting a particular service vendor 156 to recommend.

The service management module 214 is also configured to transmit a message identifying the recommended service vendor 156 to the owner 152 of the rental property 120. In some embodiments, the message may be transmitted to the owner 152 of the property via the remote computing device 140 and/or another computing device. In such embodiments, the service management module 214 may be configured to receive an approval message indicative of an approval by the owner 152 of the recommended service vendor 156. In response to receiving the approval message, the service management module 214 may be configured to schedule the approved service vendor 156 to perform the required service. In some embodiments, the service management module 214 is configured to schedule a backup service vendor 156 to perform the required service in response to determining that the preferred service vendor 156 and/or the approved service vendor 156 is unavailable to perform the required service. The backup service vendor 156 may be specified by the owner 152 of the rental property 120 and/or automatically recommended by the service management module 214.

The dispute resolution management module 216 is configured to facilitate the resolution of disputes associated with the rental property 120 (or multiple rental properties). For example, in some embodiments, the dispute resolution management module 216 may process one or more rules or policies that define how disputes are to be resolved between the owner 152 of the rental property 120 and one or more renters 154 and/or service vendors 156. In such embodiments, the dispute resolution management module 216 may be configured to automatically resolve a dispute or provide a recommended compromise based on the rules and policies. It should be appreciated that the dispute resolution management module 216 may also resolve disputes between the owner 152 of the rental property 120 and other individuals and entities. For example, the dispute resolution management module 216 may be configured to automatically resolve a dispute or provide a recommended compromise between the owner 152 of the rental property 120 and one or more third party marketing providers and/or online vacation marketplaces. Additionally, the rules and policies processed by the dispute resolution management module 216 may be configured or otherwise defined by the property owner 152, the renter(s) 154, the service vendor(s) 156, an administrator of the rental management device 102, and/or any other individual or entity interacting with the rental management device 102.

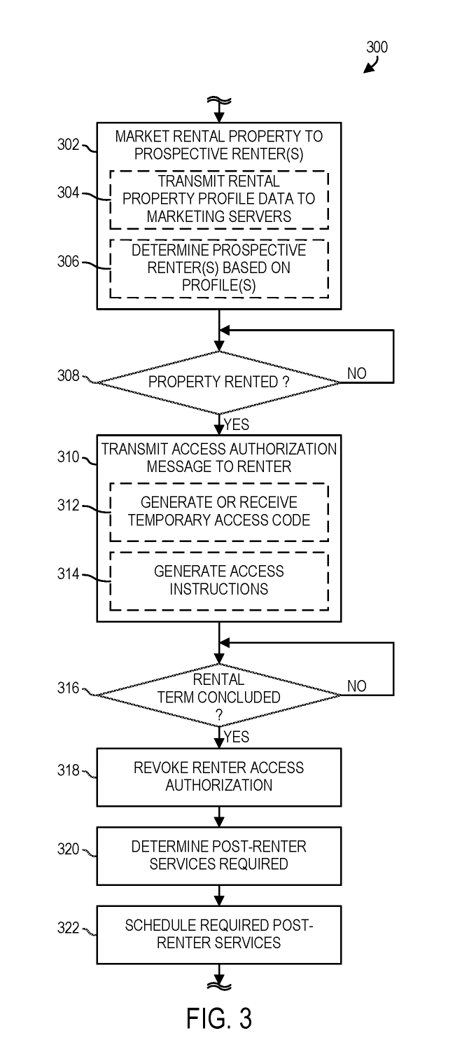

Referring now to FIG. 3, a method 300 for managing property rentals that may be executed by the rental management device 102 begins with block 302. In block 302, the rental management device 102 markets the rental property 120 (or multiple rental properties) to one or more prospective renters 154. To do so, rental property data 112 (e.g., rental property description information, privacy information, renter requirements, rental availability, rental restrictions, rental pricing information, preferences, owner profile data, etc.) may be transmitted to the prospective renter(s) 154 via one or more web pages (e.g., HTML pages, PHP pages, etc.) or messages (e.g., email messages, short message service messages, in-app messages, etc.). In some embodiments, the rental property data 112 may be transmitted directly to the prospective renter(s) 154 via the remote computing device 140 or it may be transmitted indirectly via another computing device. For example, in some embodiments, the rental management device 102 in block 304 transmits the rental property data 112 to one or more of the third party marketing servers 160. In such embodiments, the prospective renter(s) 154 may access or otherwise obtain the rental property data 112 from the third party marketing server(s) 160. Additionally or alternatively, the rental management device 102 may include a web server and may host or otherwise enable the prospective renter(s) 154 to access or otherwise obtain the rental property data 112 therefrom.

In some embodiments, in block 306, the rental management device 102 determines the prospective renters 154 to which the rental property data 112 should be transmitted. To do so, the rental management device 102 may compare the rental property data 112 associated with the rental property 120 to a renter profile generated for each prospective renter 154. In such embodiments, the renter profile generated for each prospective renter 154 may include contact and/or preference data (e.g., preferred locations, floorplans, price points, payment methods, etc.) associated with each of the prospective renters 154. If the rental management device 102 determines that the rental property data 112 for the rental property 120 matches or meets information included in a particular renter's profile, that renter may be determined by the rental management device 102 to be a prospective renter 154.

In decision block 308, the rental management device 102 determines whether the rental property 120 is rented. That is, the rental management device 102 determines whether the rental property 120 is reserved, booked, or otherwise subject to a rental agreement. If, in decision block 308, the rental management device 102 determines that the rental property 120 is rented, the method 300 advances to block 310. If, however, the rental management device 102 determines instead that the rental property 120 is not reserved, booked, or otherwise subject to a rental agreement, the method 300 loops back to decision block 308 and the rental management device 102 continues monitoring for rental of the rental property 120.

In block 310, the rental management device 102 transmits an access authorization message to the renter 154 of the rental property 120 via the remote computing device 140 and/or another computing device. The access authorization message includes access information for gaining entry to the rental property 120 during a rental term (e.g., a time period or duration in which the rental property 120 has been rented rented). In some embodiments, the access authorization message may be transmitted to a user 150 (e.g., the owner 152 of the rental property 120, the renter 154 of the rental property 120, the service vendor(s) 156 of the rental property 120, etc.) via the remote computing device 140 as one or more email messages, in-app messages, short message service messages, or any type of message suitable for transmitting access authorization information. In embodiments in which the rental property 120 includes one or more electronic access control device(s) 122 (e.g., electronic or digital lock devices), the access information may include an access code for gaining entry into the rental property 120 or a portion thereof. In some embodiments, the access code may be used by the owner 152 of the rental property 120, the renter 154 of the rental property, and/or one or more service vendor(s) 156 approved to perform service on the rental property 120. The access code may be embodied as a temporary access code that may be revoked upon conclusion of a rental term or in response to a revocation request. Additionally, in some embodiments, the rental management device 102 in block 312 may generate the access code and/or receive a previously generated access code from the access control device(s) 122.

Additionally or alternatively, the access information may include access instructions for gaining entry to the rental property 120 during the rental term. In such embodiments, in block 314, the rental management device 102 may generate the access instructions for gaining entry to the rental property 120 during the rental term. In embodiments in which the rental property includes one or more manual access control device(s) 122 (e.g., manual lock devices), the access instructions may be used by the owner 152, renter 154, and/or service vendor(s) 156 of the rental property 120 to obtain a physical key required for gaining entry into the rental property 120 or a portion thereof.

In decision block 316, the rental management device 102 determines whether the rental term has concluded. For example, the rental management device 102 determines whether an amount of time for which the rental property 120 was rented by the renter 154 has expired or otherwise lapsed. If, in decision block 316, the rental management device 102 determines that the rental term has concluded, the method 300 advances to block 318. If, however, the rental management device 102 determines instead that rental term has not yet concluded, the method 300 loops back to decision block 316 to continue monitoring whether the rental term has concluded.

In block 318, the rental management device 102 revokes the authorization to access the rental property 120 or a portion thereof. In doing so, the rental management device 102 prevents the renter 154 (or other user 150) from gaining entry to the rental property 120 or a portion thereof. To do so, in some embodiments, the rental management device 102 invalidates the access information for gaining entry to the rental property 120. Additionally or alternatively, the rental management device 102 rescinds or deactivates the access code in embodiments in which the rental property 120 includes electronic access control device(s) 122 (e.g., electronic or digital lock devices). It should be appreciated that any suitable mechanism for revoking the renter's 154 (or other user's 150) authorization to access the rental property 120 is contemplated.

In block 320, the rental management device 102 determines whether any services are required to be performed at the rental property 120. For example, in some embodiments, the rental management device 102 determines whether the rental property 120 requires housekeeping, maintenance, groundskeeping, or any other type of service after the rental term has concluded. It should be appreciated that in some embodiments, the rental management device 102 may also determine whether the rental property 120 requires any services prior to the start of a rental term. In block 322, the rental management device 102 may automatically schedule, confirm, track, and process payment for any services required at the rental property 120.

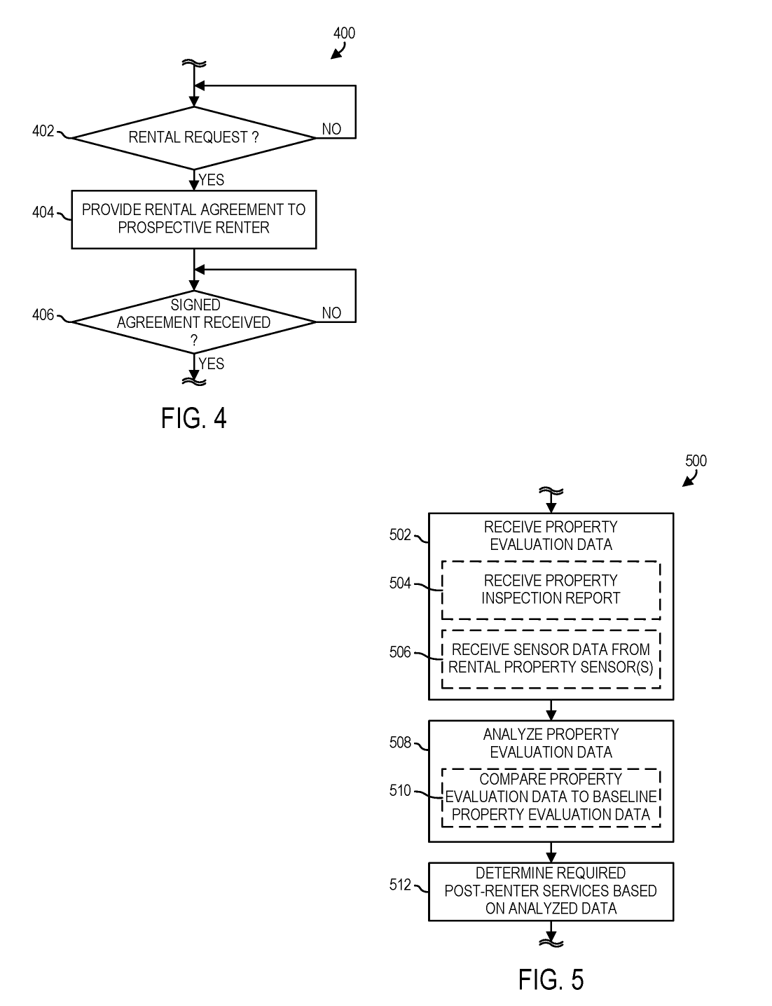

Referring now to FIG. 4, a method 400 for generating a binding rental agreement that may be executed by the rental management device 102 begins with decision block 402. In decision block 402, the rental management device 102 determines whether a request to rent the rental property 120 is received from a prospective renter 154. In some embodiments, the rental request may be received from the remote computing device 140. If, in decision block 402, the rental management device 102 determines that a rental request is received, the method 400 advances to block 404. If, however, the rental management device 102 determines instead that a rental request is not received, the method 400 loops back to decision block 402 and the rental management device 102 continues to monitor for the receipt of a rental request.

In block 404, the rental management device 102 provides a rental agreement for the rental property 120 to the prospective renter 154 via the remote computing device 140. Subsequently, in decision block 406, the rental management device 102 determines whether a signed version of the rental agreement is received from the prospective renter 154. In some embodiments, the signed version of the rental agreement may be embodied as a version of the rental agreement digitally signed by the prospective renter 154. In other embodiments, the signed version of the rental agreement may be embodied as an electronic copy of the rental agreement physically signed by the prospective renter 154. If, in decision block 406, the rental management device 102 determines that a signed version of the rental agreement is received, a binding rental agreement (e.g., a contract) may be created between the property owner 152 and the prospective renter 154. If, however, the rental management device 102 determines instead that a signed rental agreement is not received, the method 400 loops back to decision block 406 and the rental management device 102 continues to monitor for the receipt of a signed rental agreement.

Referring now to FIG. 5, a method 500 for evaluating the rental property 120 and determining required services that may be executed by the rental management device 102 begins with block 502. In block 502, the rental management device 102 receives property evaluation data associated with the rental property 120. The property evaluation data may be received at the conclusion of the rental term of the rental property 120. In some embodiments, the property evaluation data may be embodied as an inspection report indicative of a condition of the rental property 120 after conclusion of the rental term. In such embodiments, in block 504, the inspection report may be received from an independent inspector or other service vendor 156 selected by the owner 152 to inspect the rental property 120 after conclusion of the rental term. The inspection report may include information responsive to a predefined or reference checklist provided by the owner 152 indicating areas or categories (e.g., cleanliness, broken objects or objects in need of repair, missing items, required maintenance tasks, etc.) of the rental property 120 to be evaluated. In some embodiments, the independent inspector may be automatically selected by the rental management device 102.

Additionally or alternatively, in some embodiments, the property evaluation data may be embodied as sensor data indicative of a condition of the rental property 120 after conclusion of the rental term. In such embodiments, in block 506, the sensor data may be received from one or more sensors 124 of the rental property 120. As discussed, the sensor(s) 124 may be embodied as any type of device or devices configured to sense characteristics or conditions of the rental property 120.

In block 508, the rental management device 102 analyzes the received property evaluation data. In some embodiments, in block 510, the rental management device 102 compares the received property evaluation data to baseline property evaluation data associated with the rental property 120. The baseline property evaluation data may be embodied as a data indicative of a reference or default condition level that the owner 152 requires the rental property 120 to be returned to after conclusion of the rental term. For example, the baseline property evaluation data may include data indicative of the requisite position of different objects (e.g., furniture, electronics, etc.) within the rental property 120, the requisite condition of the objects within the rental property 120, the requisite cleanliness of the rental property 120, and any other requisite condition within the rental property 120. In some embodiments, the rental management device 102 may compare the received property evaluation data to the baseline property evaluation data associated with the rental property 120 to determine any differences.

In block 512, the rental management device 102 determines the service(s) that are required to be performed at the rental property 120 based on the analyzed property evaluation data. As discussed, in some embodiments, the rental management device 102 may compare the received property evaluation data to the baseline property evaluation data to determine any differences. In such embodiments, the differences may be indicative of a particular service (e.g., housekeeping, maintenance, groundskeeping, etc.) that is required to be performed at the rental property 120.

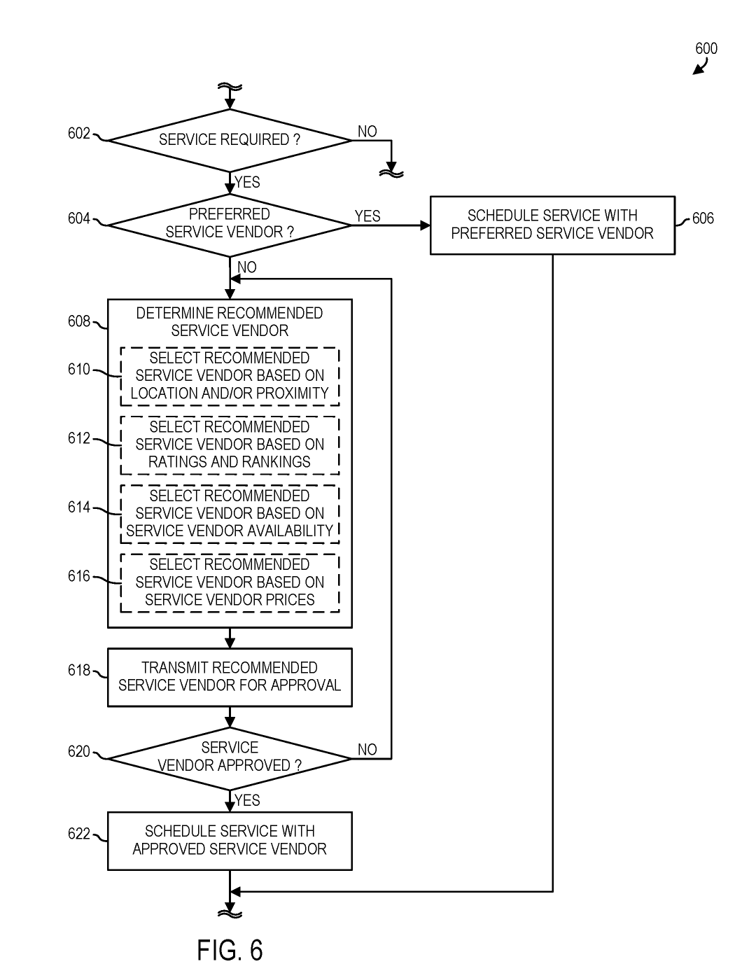

Referring now to FIG. 6, a method 600 for selecting a service vendor and scheduling a required service that may be executed by the rental management device 102 begins with decision block 602. In decision block 602, the rental management device 102 determines whether a service is required to be performed at the rental property 120. In some embodiments, rental management device 102 determines the service(s) that are required to be performed at the rental property 120 based on the determined differences between the received property evaluation data and the baseline property evaluation data associated with the rental property 120. If, in decision block 602, the rental management device 102 determines that a service is required to be performed at the rental property 120, the method 600 advances to decision block 604.

In decision block 604, the rental management device 102 determines whether the owner 152 of the rental property 120 has specified a preferred or default service vendor 156 to perform the required service. If, in decision block 604, the rental management device 102 determines that the owner 152 has specified a preferred or default service vendor to perform the required service, the method 600 advances to block 606 in which the rental management device 102 automatically schedules the preferred service vendor 156 to perform the service. If, however, the rental management device 102 determines instead that the owner 152 has not specified a preferred or default service vendor to perform the required service, the method 600 advances to block 608.

In block 608, the rental management device 102 selects or determines a recommend service vendor 156 from a plurality of service vendors 156 to perform the required service. To do so, the rental management device 102 selects or determines the recommended service vendor 156 based on various different criteria or a combination of criteria. For example, in block 610, the rental management device 102 may select or determine a particular service vendor 156 to recommend based at least in part on, or otherwise as a function of, a location of each of the plurality of service vendors 156 or a proximity of each of the plurality of service vendors 156 to the rental property 120. In another example, in block 612, the rental management device 102 may select or determine a particular service vendor 156 to recommend based at least in part on, or otherwise as a function of, a rating of each of the plurality of service vendors 156 and/or a ranking of each of the plurality of service vendors 156. In another example, in block 614, the rental management device 102 may select or determine a particular service vendor 156 to recommend based at least in part on, or otherwise as a function of, an availability of each of the plurality of service vendors 156. In yet another example, in block 616, the rental management device 102 may select or determine a particular service vendor 156 to recommend based at least in part on, or otherwise as a function of, a service price associated with each of the plurality of service vendors 156, and/or a combination thereof. It should be appreciated that the rental management device 102 may utilize any other criteria for determining or selecting a particular service vendor 156 to recommend.

In block 618, the rental management device 102 transmits a message identifying the recommended service vendor 156 to the owner 152 of the rental property 120. In some embodiments, the message may be transmitted to the owner 152 of the property via the remote computing device 140 and/or another computing device. In decision block 620, the rental management device 102 determines whether an approval message indicative of the owner's 152 approval of the recommended service vendor 156 is received. If, in decision block 620, the rental management device 102 determines that the approval message is received, the method 600 advances to block 622 in which the rental management device 102 schedules the approved service vendor 156 to perform the service.

In various embodiments disclosed herein, a single component can be replaced by multiple components and multiple components can be replaced by a single component to perform a given function or functions. Except where such substitution would not be operative, such substitution is within the intended scope of the embodiments.

Some of the figures can include a flow diagram. Although such figures can include a particular logic flow, it can be appreciated that the logic flow merely provides an exemplary implementation of the general functionality. Further, the logic flow does not necessarily have to be executed in the order presented unless otherwise indicated. In addition, the logic flow can be implemented by a hardware element, a software element executed by a computer, a firmware element embedded in hardware, or any combination thereof.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the invention to be defined by the claims appended hereto.

We claim:

1. A rental management device to manage rental properties, the rental management device comprising:
a reservation management module to determine whether a rental property is rented;
a property access management module to transmit an access authorization message to a renter of the rental property via a remote computing device in response to a determination that the rental property is rented, wherein the access authorization message comprises access information for gaining entry to the rental property during a rental term; and
a rental property management module to (i) determine whether the rental term is concluded, (ii) determine whether the rental property requires service in response to a determination that the rental term is concluded, and (iii) schedule a required service for the rental property in response to a determination that the rental property requires service.

2. The rental management device of claim 1, wherein the property access management module is further to generate an access code for gaining entry to the rental property during the rental term via an electronic lock device of the rental property; and
wherein the access information of the access authorization message comprises the access code.

3. The rental management device of claim 1, wherein the property access management module is further to receive, from an electronic lock device of the rental property, a generated access code for gaining entry to the rental property during the rental term; and
wherein the access information of the access authorization message comprises the generated access code.

4. The rental management device of claim 1, wherein the access information of the access authentication message comprises instructions for gaining entry to the rental property during the rental term.

5. The rental management device of claim 1, wherein the property access management module is further to (i) revoke authorization to access the rental property in response to a determination that the rental term is concluded and (ii) prevent the renter from gaining entry to the rental property.

6. The rental management device of claim 1, wherein the reservation management module is further to market the rental property to one or more prospective renters.

7. The rental management device of claim 6, wherein the reservation management module is further to determine the one or more prospective renters for the rental property based on a renter profile generated for each of the one or more prospective renters, wherein the renter profile for each of the one or more prospective renters comprises one or more of preferred location information, preferred rental floorplan information, preferred rental price information, preferred payment methods, or historical rental information; and
wherein to market the rental property to the one or more prospective renters comprises to market the rental property to the determined one or more prospective renters for the rental property.

8. The rental management device of claim 1, wherein the reservation management module is further to (i) receive, from the remote computing device, a request from a prospective renter to rent the rental property, (ii) transmit a rental agreement to the prospective renter for rental of the rental property, and (iii) receive a signed rental agreement from the prospective renter via the remote computing device, wherein the signed rental agreement comprises the transmitted rental agreement digitally signed by the prospective renter; and
wherein to determine whether the rental property is rented comprises to determine whether the signed rental agreement is received from the prospective renter.

9. The rental management device of claim 1, wherein the rental property management module is further to (i) receive property evaluation data associated with the rental property, wherein the property evaluation data is indicative of a condition of the rental property obtained in response to the determination that the rental term is concluded and (ii) analyze the property evaluation data; and
wherein to determine whether the rental property requires service comprises to determine whether the rental property requires service as a function of the analyzed property evaluation data.

10. The rental management device of claim 9, wherein the property evaluation data comprises a property inspection report;
wherein to analyze the property evaluation data comprises to compare the property inspection report to baseline property evaluation data; and
wherein to determine whether the rental property requires service comprises to determine whether the rental property requires service based on the comparison of the property inspection report to the baseline property evaluation data.

11. The rental management device of claim 1, wherein the rental property management module is further to (i) receive sensor data from a sensor of the rental property and (ii) compare the received sensor data to baseline property evaluation data; and
wherein to determine whether the rental property requires service comprises to determine whether the rental property requires service based on the comparison of the received sensor data to the baseline property evaluation data.

12. The rental management device of claim 1, wherein the rental property management module is further to (i) determine a recommended service vendor from a plurality of service vendors to perform the required service, (ii) transmit a message identifying the recommended service vendor to perform the required service to an owner of the rental property for approval, and (iii) receive an approval message indicative of an approval by the owner of the recommended service vendor; and
wherein to schedule the required service for the rental property comprises to schedule the recommended service vendor to perform the required service in response to receipt of the approval message.

13. The rental management device of claim 1, wherein the rental property management module is further to determine whether a preferred service vendor is specified to perform the required service; and
wherein to schedule the required service for the rental property comprises to schedule the preferred service vendor to perform the required service in response to a determination that the preferred service vendor is specified.

14. One or more machine-readable storage media comprising a plurality of instructions stored thereon that in response to being executed by a rental management computing device, cause the rental management computing device to:
determine whether a rental property is rented;
transmit an access authorization message to a renter of the rental property via a remote computing device in response to a determination that the rental property is rented, wherein the access authorization message comprises access information for gaining entry to the rental property during a rental term;
determine whether the rental term is concluded;
determine whether the rental property requires service in response to a determination that the rental term is concluded; and
schedule a required service for the rental property in response to a determination that the rental property requires service.

15. The one or more machine-readable storage media of claim 14, wherein the plurality of instructions further cause the rental management computing device to:
receive property evaluation data associated with the rental property, wherein the property evaluation data is indicative of a condition of the rental property obtained in response to the determination that the rental term is concluded;
analyze the property evaluation data; and
wherein to determine whether the rental property requires service comprises to determine whether the rental property requires service as a function of the analyzed property evaluation data.

16. The one or more machine-readable storage media of claim 14, wherein the plurality of instructions further cause the rental management computing device to:
determine a recommended service vendor from a plurality of service vendors to perform the required service;
transmit a message identifying the recommended service vendor to perform the required service to an owner of the rental property for approval;
receive an approval message indicative of an approval by the owner of the recommended service vendor; and
wherein to schedule the required service for the rental property comprises to schedule the recommended service vendor to perform the required service in response to receipt of the approval message.

17. The one or more machine-readable storage media of claim 14, wherein the plurality of instructions further cause the rental management computing device to determine whether a preferred service vendor is specified to perform the required service; and
wherein to schedule the required service for the rental property comprises to schedule the preferred service vendor to perform the required service in response to a determination that the preferred service vendor is specified.

18. A method for managing rental properties, the method comprising:
determining, by a rental management device, whether a rental property is rented;
transmitting, by the rental management device and in response to determining that the rental property is rented, an access authorization message to a renter of the rental property via a remote computing device, wherein the access authorization message comprises access information for gaining entry to the rental property during a rental term;
determining, by the rental management device, whether the rental term is concluded;
determining, by the rental management device and in response to determining that the rental term is concluded, whether the rental property requires service; and
scheduling, by the rental management device and in response to determining that the rental property requires service, the required service for the rental property.

19. The method of claim 18, further comprising:
receiving, by the rental management device, property evaluation data associated with the rental property, wherein the property evaluation data is indicative of a condition of the rental property obtained in response to determining that the rental term is concluded;
analyzing, by the rental management device, the property evaluation data; and
wherein determining whether the rental property requires service comprises determining whether the rental property requires service as a function of the analyzed property evaluation data.

20. The method of claim 18, further comprising:
determining, by the rental management device, a recommended service vendor from a plurality of service vendors to perform the required service;
transmitting, by the rental management device, a message identifying the recommended service vendor to perform the required service to an owner of the rental property for approval;
receiving, by the rental management device, an approval message indicative of an approval by the owner of the recommended service vendor; and
wherein scheduling the required service for the rental property comprises scheduling the recommended service vendor to perform the required service in response to receiving the approval message.
